(19) United States
(12) Patent Application Publication
(10) Pub. No.: US 2016/0203534 A1
(43) Pub. Date: Jul. 14, 2016

(54) SYSTEM AND METHOD FOR ONLINE SHOPPING COMMUNICATION AUTHENTICATION OF LOCAL GOODS PICKING-UP

(71) Applicant: Kamfu WONG, Kowloon (HK)

(72) Inventor: Kamfu WONG, Kowloon (HK)

(21) Appl. No.: 14/915,703

(22) PCT Filed: Sep. 3, 2013
(86) PCT No.: PCT/CN2013/082875

§ 371 Date: Mar. 1, 2016

(51) Int. Cl. G06Q 30/06; H04B 1/3818; G06Q 20/32; G06Q 20/40

(52) U.S. Cl. CPC G06Q 30/0609; G06Q 20/4014; H04B 1/3818; G06Q 20/3224

(57) ABSTRACT

The present invention relates to a system and a method for online shopping communication authentication of local goods picking-up. The system comprises an online shopping server, an online shopping terminal and a subscriber phone. The online shopping server stores the online shopping information of every subscriber and the store account information of every merchant, responsible for authenticating and processing orders submitted by the online shopping terminal, approving the processing and settlement. The online shopping terminal is used for recording the shopping information submitted by the subscriber, reading the number of an online shopping card of the subscriber, generating an order, submitting the order to the online shopping server for reviewing the order, and receiving the confirmation information of approval. The subscriber phone is installed with an on-line shopping application for confirming the order and receiving the confirmation information of approval. By using the system and the method provided by the present invention, security and reliability of the communication authentication can be guaranteed, and the effect is same as that the consumer purchases at the location of the online shopping server directly using a credit card. The implementation of the system and the method for online shopping communication authentication of local goods picking-up according to the present invention can bring good social and economic benefits, and is good for both customers and sellers.

### BACKGROUND OF THE INVENTION

1. Technical Field

The present invention relates to electronic commerce technology, in particular to a method and a system for online shopping communication authentication of local goods picking-up.

2. Description of Related Art

As the global economic integration progress speeds up, mutual visits among people from different places become more and more frequent, and commodity circulation is also accelerated. Travel and shopping abroad generated thereby gradually become a way for prompting consumption. However, quite many people cannot directly shop at local places for different reasons, but turn to electronic commerce, namely online shopping. In the current electronic commercial activities, for subscribers and merchants at the same place, the commodities sold are commonly available on the market. If an online shopping platform can be established in a large scope, subscribers can purchase all kinds of commodities without going abroad. This will definitely promote consumption, enhance market prosperity and improve living quality. However, the current electronic commerce form fails to solve the problem of local goods picking-up through online shopping and the difficulty is that there has not been secure and reliable communication authentication mechanism yet.

Besides, credit cards are commonly used for purchases, and merchants need to pay handling charges for the credit card network, usually at a rate of 2-3% of the purchase amount. Because the credit card payment involves a lot of units, the handling charges are shared by those service providing units, for example the acquiring bank, the issuing bank, the credit card network service supplier, etc., which results in the rate is difficult to lower down, affecting the income of merchants. Furthermore, there are sale taxes in many countries and territories. Subscribers need to pay sales taxes as long as they buy goods locally, not only imposing burden on subscribers, but also affecting consumption willingness. This is a problem to be solved.

### BRIEF SUMMARY OF THE INVENTION

The technical problem solved by the present invention is to provide a system and a method for online shopping communication authentication of local goods picking-up, which are multiple applications that subscribers can buy goods on line and pick goods up locally.

The present invention is carried out in this way. A system for online shopping communication authentication of local goods picking-up is provided. The system comprises an online shopping server (1), an online shopping terminal (2) and a subscriber phone (6), wherein the online shopping server (1) and the online shopping terminal (2) are respectively located at different sites.

The online shopping server (1) stores the online shopping information of every subscriber and the store account information of every merchant, responsible for authenticating and processing orders submitted by the online shopping terminal (2), approving the processing and settlement.

The online shopping terminal (2) is used for recording the shopping information submitted by the subscriber, reading the number of an online shopping card (3) of the subscriber, generating an order, submitting the order to the online shopping server (1) for reviewing the order, and receiving the confirmation information of approval sent back by the online shopping server (1).

The subscriber phone (6) is installed with an on-line shopping application for confirming the order and receiving the confirmation information of approval sent by the online shopping server (1).

The order submitted by the online shopping terminal (2) includes goods name, quantity, picking-up site, payment amount, number of the online shopping card (3) of the subscriber, etc.

Based on the above mentioned system for online shopping communication authentication of local goods picking-up, the present invention also provides a method for online shopping communication authentication of local goods picking-up, characterized in that, the method is carried out as follows:

the online shopping terminal (2) records the order information submitted by the subscriber, calculates the payment amount according to the recorded information, reads the card number of the online shopping card (3) of the subscriber, generates an order according to the above information, and submits the order to the online shopping server (1) for approval;

the online shopping server (1), after approving the information, transmits the information of the online shopping order to the online shopping application of the subscriber phone (6) to inform the subscriber; the subscriber confirms the order information through the online shopping application if she/he agrees with the online transaction; the online shopping server (1) approves the transaction of the order after confirmation, and respectively sends the approval success information to the online shopping terminal (2) and the online shopping application of the subscriber phone (6) to inform goods picking-up.

The subscriber confirms the online transaction by entering the PIN.

Thus, the objectives of the present invention are well fulfilled.

The implementation of the system and the method for online shopping communication authentication of local goods picking-up according to the present invention can bring good social and economic benefits and is good for both customers and sellers.

According to the system and the method for online shopping communication authentication of local goods picking-up of the present invention, the online shopping sites and the servers are located at different places, while the sites of online shopping authentication and approval are where the server is located, for example Hong Kong. Besides, local goods picking-up is employed. The goods are directly delivered to the subscribers locally. When the subscribers shop on line by using the system and the method provided by the present invention, security and reliability of the communication authentication can be guaranteed, and the effect is same as that a consumer purchases at the location of the online shopping server directly using a credit card and picks up goods at the location of the online shopping after payment. Besides, in the whole process of online shopping , the operation of the online shopping terminal (2) and the goods picking-up both occur at the site where the store is located, but the online transaction is not performed at the site where the store is located, so it needs not to pay sales tax and a great amount of tax fees can be saved for the subscriber.

### BRIEF DESCRIPTION OF THE SEVERAL VIEWS OF THE DRAWINGS

FIG. 1 is a schematic view of the first embodiment of the system for online shopping communication authentication of local goods picking-up according to the present invention.

FIG. 2 is a schematic view of the second embodiment of the system for online shopping communication authentication of local goods picking-up according to the present invention.

FIG. 3 is a schematic view of the third embodiment of the system for online shopping communication authentication of local goods picking-up according to the present invention.

FIG. 4 is a schematic view of the fourth embodiment of the system for online shopping communication authentication of local goods picking-up according to the present invention.

In the figures, the same numbers represent the same devices and parts. The figures are schematic, used for describing the composition of the system and the main features of the method.

### DETAILED DESCRIPTION OF THE INVENTION

The method of present invention is described in further detail with reference to the attached drawings.

See FIG. 1. FIG. 1 is a schematic view of the first embodiment of the system for online shopping communication authentication of local goods picking-up according to the present invention. The system in FIG. 1 comprises an online shopping server (1), online shopping terminals (2) located at merchants all over the world, subscribers' online shopping cards (3) and subscriber phones (6), a local mobile phone network (4), a China Mobile Phone Network (5) and a bank network (8).

Wherein, the online shopping server (1) can be placed in Hong Kong, storing the online shopping accounts of subscribers and the merchant accounts. The online shopping server (1) is responsible for handling the online transactions and settlement carried out through the online shopping terminals (2), receiving payments through the online shopping accounts of the subscriber according to the online shopping transaction, and storing the payment into corresponding merchant accounts after deducting the handling charge. The merchants can indicate the online shopping server (1) to regularly and automatically transfer the money from the merchant account to the bank accounts of the merchants through the bank network (8).

The site of all online transactions is the site where the online shopping server (1) is located, for example, Hong Kong, so the merchants and the subscribers need not to pay any sales tax; the picking-up sites are the sites where the merchants selling goods on line are located, so the subscribers can pick up the goods at the merchants immediately after the online shopping transaction.

Further refer to FIG. 1. As shown in FIG. 1, the online shopping terminals (2) are terminals used by the subscribers for online shopping. Those terminals are placed at the merchants and equipped with communication devices inside, for example dual-card-dual-standby mobile phones. Every communication device is internally equipped with a first SIM card and a second SIM card; the first SIM card can be issued by large-scale mobile operators, for example, by the China Mobile Phone Network (5), as the identity of the online shopping terminal (2); the online shopping terminal (2) has an access to the local mobile phone network (4) of the site where the merchant is located as a roamer through the first SIM card; the online shopping server (1) authenticates the identity through the China Mobile Phone Network (5); the second SIM card is issued by an operator of the local mobile phone network (4) of the site where the merchant is located; the online shopping terminal (2) has an access to the local mobile phone network (4) as an local identity through the second SIM card, and exchanges data with the online shopping server (1) through the local mobile phone network (4).

Further refer to FIG. 1. FIG. 1 shows the online shopping card (3) of a subscriber, which is an online account voucher for the subscriber to go shopping at the online shopping server (1). The subscriber must pre-install an online shopping application on his/her mobile phone (6). The online shopping application is bound with the IMEI (International Mobile Equipment Identifier) and/or SIM card and/or phone number of the subscriber phone (6), and sets a PIN in the online shopping account for confirming the online shopping.

In an embodiment, the on-shopping card (3) of the subscriber can be issued by China Mobile. A China Mobile SIM card and an online shopping account can be bound as a package and issued to the subscriber by the merchant. When receiving the online shopping card (3), the subscriber is required to make a call to the online shopping server (1) by using the attached SIM card to bind the number of his/her mobile phone (6), credit card account or debit card account or bank account to the one-line shopping account and set a PIN. Once this is completed, the online shopping account is opened finally.

When the subscriber is shopping at the merchant, according to information such as the goods name, quantity, picking-up site, payment amount and the card number of the online shopping card (3) of the subscriber, an order is first generated by the online shopping terminal (2) and then is sent to the online shopping server (1) for approval; the online shopping server (1) sends the information about the online shopping transaction to the online shopping application of the subscriber phone (6) to inform the subscriber; and the subscriber confirms through the online application in the mobile phone (6) if agrees with the on-line transaction, for example, by entering a confirmation password. The online shopping server (1) proves the transaction of the order after confirmation, and respectively sends the approval success information to the online shopping terminal (2) and the online shopping application of the subscriber phone (6). The subscriber can pick up the goods after the approval , thus completing the entire online shopping procedure.

In the embodiment of the present invention, the online shopping account of each subscriber is bound with his/her smart phone (6), and then the subscriber can shop on line at merchants's online shopping terminals (2) all over the world . The subscriber can pre-store money in the online shopping account, shop on line and pay with the money in the account. In addition, for some quality subscribers, the merchant can confer a credit amount to the online shopping account of each of those quality subscribers at its own will, and even if the money in the online shopping account is insufficient, the subscribers still can pay the goods by using the credit amount so as to stimulate the subscribers to buy more goods at the store. The credit amount conferred by the merchant is recorded in the store account, and the merchant himself/herself is the sponsor, so the credit amount can only be used for transaction at this store.

For merchants, every merchant must join in the online shopping server (1) in advance to become a branch of the online shopping server (1), and every merchant is equivalent to a special online shopping store. The merchant must open a store account at the online shopping server (1), register own bank account and be distributed with an online shopping terminal (2) relevant to the online shopping server (1). Inside every online shopping terminal (2), an SIM card is included for authentication. The SIM card may be a card issued by China Mobile. All transactions made through the merchant's online shopping terminal (2) are automatically recorded in the store account of the merchant, and during settlement, the receivables of the merchant are stored in the bank account of the merchant.

Further refer to FIG. 1. The method employed by the system shown in FIG. 1 is carried out by the following steps (represented by A):

A1: When the subscriber shops at the merchant's store on line, the merchant inputs the name and quantity of the selected goods and the picking-up site through the online shopping terminal (2); the picking-up site can be selected by the subscriber, including the local goods picking-up and the receiving addresses defined by the subscriber; local goods picking-up means that the site where the merchant is located is defined as the picking-up site, and the subscriber can pick up the goods purchased on line after the transaction; of course, the merchant can sell the goods out of stock at local site at present on the Internet and after the goods arrive, inform the subscriber to pick up the goods or deliver the goods through a logistics service.

A2: The online shopping terminal (2) calculates the payment amount according to the name, quantity and picking-up site of the goods; then the subscriber places his/her online shopping card (3) on the online shopping terminal (2) such that the card number can be read, wherein the card number can be read by means of NFC, bar code, magnetic tape, etc.; after obtaining the card number, the online shopping terminal (2) generates an order according to some information, e.g., the name, quantity and picking-up site of the goods, the payment amount and the card number of the online shopping card (3), etc., and then sends the order to the online shopping server (1) for approval.

A3: The online shopping server (1) finds out the phone number of the subscriber phone (6) according to the card number of the online shopping card (3), and then sends the information about the online shopping transaction, including the merchant name, the goods name, the payment amount, the picking-up site, etc., to the online shopping application of the subscriber phone (6) to ask the subscriber for confirmation.

A4: The subscriber inputs the PIN through the online shopping application of the subscriber phone (6) if agrees with the online transaction; the online shopping server (1) approves the transaction of the order after confirming that the PIN is correct, and respectively sends the approval success information to the online shopping terminal (2) and the online shopping application of the subscriber phone (6).

A5: If the subscriber selects local goods picking-up, the merchant can immediately deliver the goods to the subscriber; and if the subscriber selects self-defined picking-up site, the merchant can deliver the goods to the subscriber through logistics services.

Further refer to FIG. 1. The online shopping card (3) shown in FIG. 1 is an NFC smart card printed with a one-dimensional bar code, a two-dimensional bar code and a magnetic tape respectively loaded with card number. The card number can be read through the NFC, or through the one-dimensional bar code, or through the two-dimensional bar code, or through the magnetic tape. Moreover, the online shopping terminal (2) is provided with an NFC element, a bar code reader and a magnetic tape reader; the NFC element is used for short-distance communication with the online shopping card (3); the bar code reader is used for reading the bar code printed on the online shopping card (3); the magnetic tape reader is used for reading the magnetic tape on the online shopping card (3). When the subscriber shops on line, the online shopping terminal (2) obtains the card number of the online shopping card (3) of the subscriber through the NFC element or the bar code reader or the magnetic card reader. Besides, mobile phone with the NFC element can be used to replace the online shopping card (3) as the online shopping account voucher, which means that the online shopping cad (3) is a built-in NFC element in the subscriber phone (6), while the card number of the online shopping cad (3) is the identification information stored in the online shopping application in the subscriber phone (6).The identification information may be IEMI, SIM card number, phone number ,etc. of the subscriber phone (6).

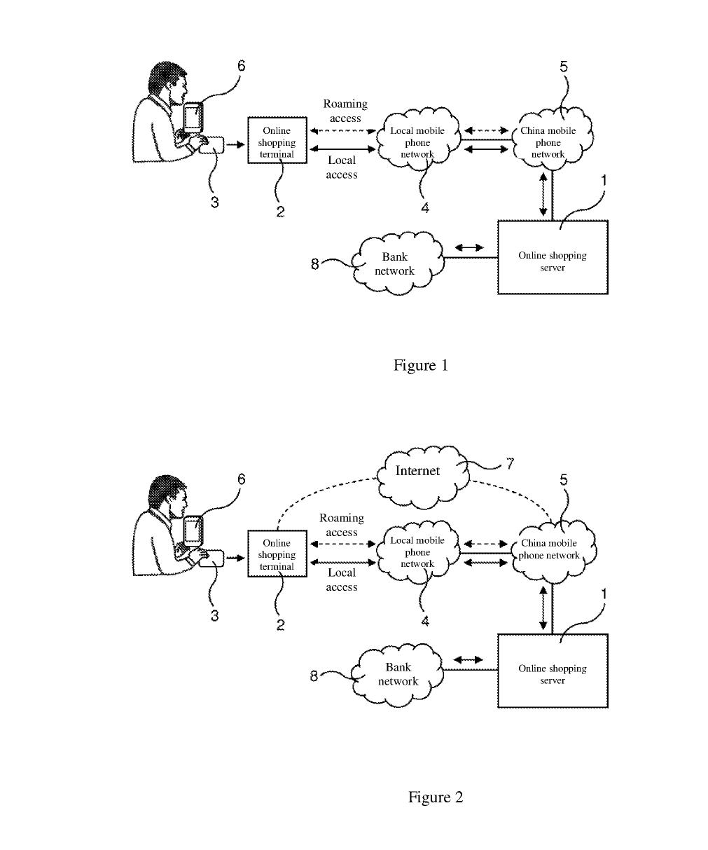

Refer to FIG. 2. FIG. 2 is a schematic view of the second embodiment of the system for online shopping communication authentication of local goods picking-up according to the present invention. As shown in the second embodiments of FIG. 2, the online shopping terminal (2) is also provided with a wired or wireless communication device, for example a WIFI communication device, an Ethernet communication device, etc. The online shopping terminal (2) can exchange data with the online shopping server (1) through the communication device via the Internet (7), replacing the second SIM card and accessing the local mobile phone network (4) as a local identifier so as to exchange data with the online shopping server (1), thus saving cost in communication.

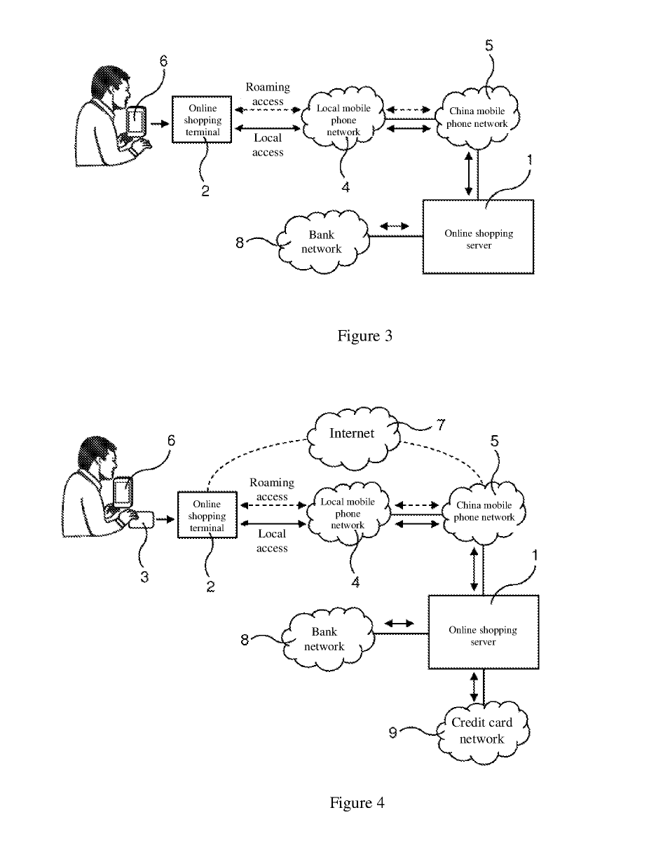

Refer to FIG. 3. FIG. 3 is a schematic view of the third embodiment of the system for online shopping communication authentication of local goods picking-up according to the present invention. As shown in FIG. 3, comparing the third embodiment with the first and the second embodiments, the main difference is that, making a call is adopted in the third embodiment to replace reading the card number of the online shopping card (3).

As shown in FIG. 3, the system includes an online shopping server (1), online shopping terminals (2) located at merchants all over the world, subscriber phones (6), a local mobile phone network (4), a China Mobile Phone Network (5) and a bank network (8), wherein the online shopping server (1) is placed in Hong Kong and operated by China Mobile, and stores the online shopping accounts of subscribers and the store accounts of the merchants. The online shopping server (1) is responsible for handling the transactions and settlement carried out through the online shopping terminals (2), receiving payments through the online shopping accounts of the subscriber according to the online shopping transaction, and storing the payment into corresponding store accounts after deducting the handling charge.

The online shopping terminals (2) are identical with those in the above embodiments, and therefore are not repeated here.

Further refer to FIG. 3. The method employed by the system shown in FIG. 3 is carried out by the following steps (represented by B):

B1: When the subscriber shops at a merchant's store on line, the merchant inputs the name and quantity of the selected goods through the online shopping terminal (2); the picking-up site can be selected by the subscriber, including the local goods picking-up and receiving address defined by the subscriber; local goods picking-up means that the site where the merchant is located is defined as the picking-up site, and the subscriber can pick up the goods after the transaction; however, the merchant can only sell the goods in stock at the local on line so as to ensure that the subscriber can locally pick up the goods right after the transaction.

B2: The online shopping terminal (2) calculates the payment amount according to the name, quantity and picking-up site of the goods; then, the subscriber uses his/her own subscriber phone (6) to call the phone number of one of the SIM cards in the online shopping terminal (2); the online shopping terminal (2) can hang up after receiving the call, there is no need to answer the call and therefore no need to pay the phone charge.

B3: The online shopping terminal (2) obtains the phone number of the subscriber phone (6) from the coming call. The online shopping terminal (2) generates an order according to the name, quantity and picking-up site of the goods, the payment amount and the phone number of the mobile phone (6) of the subscriber and sends the order to the online shopping server (1) to ask for approval.

B4: The online shopping server (1) sends the information about the online shopping transaction, including the merchant name, the goods name, the payment amount, the picking-up site, etc., to the online shopping application of the subscriber phone (6) to ask the subscriber for confirmation.

B5: The subscribers inputs the PIN through the online shopping application of the subscriber phone (6) if agrees with the online transaction; the online shopping server (1) approves the transaction of the order after checking that the PIN is correct, and respectively sends the approval success information to the online shopping terminal (2) and the online shopping application of the subscriber phone (6).

B6: If the subscriber selects local goods picking-up, the merchant can immediately deliver the goods to the subscriber; and if the subscriber selects self-defined picking-up site, the merchant can deliver the goods to the subscriber through logistics services.

As a further improvement of the present invention, the online shopping terminal (2) is attached with a camera and a palm print scanner, and then the function of the online shopping terminal (2) is more comprehensive. Wherein, the camera can be used for photographing the looks of the online shopping subscriber, which is sent by the online shopping terminal (2) to the online shopping server (1) for storage. When it is found that some person shops on line with a stolen online shopping card (3), these photographs can help the policemen to seize the thief. The palm print scanner is used for obtaining the information about the palm print characteristics or the fingerprint characteristics of the online shopping subscriber. The online shopping terminal (2) sends the obtained information about the palm print characteristics or the fingerprint characteristics to the online shopping server (1) for checkup, making sure the subscriber's identity is correct.

FIG. 4 is a schematic view of the fourth embodiment of the system for online shopping communication authentication of local goods picking-up according to the present invention. As shown in FIG. 4, the main difference among the fourth embodiment and the above-mentioned embodiments is that, in the fourth embodiment, a credit card network (9) is also provided. The online shopping server (1) can evaluate the credit amount that can be conferred to the online shopping account of the subscriber according to the current status of the credit card account of the subscriber. The subscriber should register the credit card account thereof when opening the online shopping account at the online shopping server (1), and apply for a credit card amount for the online shopping account. The online shopping sever (1) will try to swipe a sum of money equivalent to the credit amount from the credit card account via the credit card network (9). After the swiping succeeds, the online shopping server (1) can confer the credit amount of the sum of money to the online shopping account, and then the online shopping server (1) cancels the credit card transaction via the credit card network (9). In this way, the online shopping server (1) can assess the credit-goods situation of the subscriber in a safe and low-cost way, and the subscriber can shop on line by using the conferred credit amount, hence promoting the online shopping transactions.

The system and the method for online shopping communication authentication of local goods picking-up according to the present invention are described in detailed. The present invention is described with reference to the above embodiments, but the present invention is not limited to those embodiments. Various changes and modifications can be made without departing from the spirit of the present invention and the scope of the claims.

1. An online shopping terminal used by a subscriber to shop on line at a merchant, wherein, the online shopping terminal is equipped with a communication device inside; the communication device is internally equipped with a first SIM card and a second SIM card; the first SIM card servers as the identity of the online shopping terminal; the online shopping terminal has an access to a local mobile phone network of the site where the merchant is located as a roamer through the first SIM card; a online shopping server authenticates the identity through a China Mobile Phone Network; the second SIM card is issued by the operator of the local mobile phone network of the site where the merchant is located; the online shopping terminal has an access to the local mobile phone network as an local identity through the second SIM card, and exchanges data with the online shopping server through the local mobile phone network.

2. The online shopping terminal according to claim 1, wherein, in order to read the card number of the online shopping card, an NFC element is provided for short-distance communication with the online shopping card; or a bar code reader is provided to read a bar code printed on the online shopping card; or a magnetic card reader is provided to read a magnetic tape on the online shopping card.

3. The online shopping terminal according to claim 1, wherein, the communication device exchanges data with the online shopping server via the Internet, replacing the second SIM card to access the local mobile phone network as a local identity to exchange data with the online shopping server.

4. A system for online shopping communication authentication of local goods picking-up, wherein the system comprises an online shopping server, an online shopping terminal and a subscriber phone, wherein the online shopping server and the online shopping terminal are respectively located at different sites;
the online shopping server stores the online shopping account information of every subscriber and the store account information of every merchant, responsible for authenticating and handling orders submitted by the online shopping terminal, and approving the handling and settlement;
the online shopping terminal is used for recording the shopping information submitted by the subscriber, reading the number of an online shopping card of the subscriber, generating an order, submitting the order to the online shopping server for reviewing the order, and receiving the confirmation information of approval sent back by the online shopping server; and
the subscriber phone is installed with an online shopping application for confirming the order and receiving the handling information of approval sent back by the online shopping server.

5. The system for online shopping communication authentication of local goods picking-up according to claim 4, wherein, the order submitted by the online shopping terminal includes goods name, quantity, picking-up site, payment, number of the online shopping card of the subscriber, etc.

6. The system for online shopping communication authentication of local goods picking-up according to claim 4, wherein, the online shopping application in the subscriber phone is bound with the IMEI and/or SIM card and/or phone number of the subscriber phone.

7. A method for online shopping of local goods picking-up, the method comprising the following steps:
recording, by an online shopping terminal, the purchase information submitted by a subscriber, calculating the payment amount according to the recorded information, reading the card number of an online shopping card of the subscriber, generating an order according to the information, and submitting the order to an online shopping server for approval;
transmitting the information of the online shopping order to the online shopping application of a subscriber phone to inform the subscriber after the information is approved by the online shopping server; confirming the order information through the online shopping application of the subscriber phone if the subscriber agrees with the online transaction; approving, by the online shopping server, the transaction of the order after confirmation, and respectively sending the approval success information to the online shopping terminal and the online shopping application of the subscriber phone to inform goods picking-up.

8. The method for online shopping of local goods picking-up according to claim 7, wherein, subscriber confirms the online transaction by entering the PIN.

9. The method for online shopping of local goods picking-up according to claim 7, wherein, the card number of the online shopping card of the subscriber can be read by calling the phone number of one of the SIM cards of the online shopping terminal by using the subscriber phone.

10. The method for online shopping of local goods picking-up according to claim 7, wherein, during approving, also comprising obtaining the current status of the credit card account of the subscriber by accessing a credit card network via the online shopping server, so as to confer to the credit amount of the online shopping account of the subscriber.
